(19) United States
(12) Patent Application Publication
(10) Pub. No.: US 2012/0274922 A1
(43) Pub. Date: Nov. 1, 2012

(54) LIDAR METHODS AND APPARATUS

(76) Inventor: Bruce HODGE, Greenfield, NY (US)

(21) Appl. No.: 13/433,001

(22) Filed: Mar. 28, 2012

Related U.S. Application Data
(60) Provisional application No. 61/468,433, filed on Mar. 28, 2011.
(60) Provisional application No. 61/603,084, filed on Feb. 24, 2012.

(51) Int. Cl. G01P 3/36

(52) U.S. Cl. 356/28

(57) ABSTRACT

A system for detecting the trajectory of a projectile includes at least one pulsed laser transmitter configured to transmit pulsed laser light beams over a three dimensional area. At least one sensor is configured to sense the pulsed laser light beams reflected off of the projectile. A microprocessor is coupled to the laser transmitter and laser sensor to calculate a first position of the projectile at a first time based upon the first pulsed laser light beam reflected off the projectile and sensed by the laser sensor. A microprocessor calculates a second position of the projectile at a second time based upon a second pulsed laser light beam reflected off the projectile and sensed by a laser sensor. A microprocessor calculates the trajectory of the projectile based upon the first projectile position and the second projectile position and the time differences between these positions.

### CROSS REFERENCE TO RELATED APPLICATIONS

This application claims priority to U.S. Provisional Application No. 61/468,433 filed Mar. 28, 2011, entitled “TARGET SYSTEM METHODS AND APPARATUS”, and U.S. Provisional Application No. 61/603,084 filed Feb. 24, 2012, entitled “PRECISION TARGET AND DISTURBANCE RECOGNITION METHODS AND APPARATUS”. This application is related to U.S. Utility Patent Application No. 13042351-PCT 11/27426 patent Filed on Mar. 7, 2011, entitled “TARGET SYSTEM METHODS AND APPARATUS”. This application is also related to U.S. Pat. No. 5,516,113, U.S. Pat. No. 7,207,566 and U.S. Pat. No. 7,862,045. The entire contents of the patents and applications mentioned in this paragraph are incorporated herein by reference.

### COPYRIGHT NOTICE

A portion of the disclosure of this patent document contains material which is subject to copyright protection. The copyright owner has no objection to facsimile reproduction by anyone of the patent document or the patent disclosure, as it appears in the Patent & Trademark Office patent file or records, but otherwise reserves all copyright rights whatsoever.

### TECHNICAL FIELD

The present application relates to methods and apparatus for sensing and providing feedback relative to target systems to provide projectile trajectory, impact location and situational awareness in a particular environment

### BACKGROUND OF THE INVENTION

There is a need for more advanced targets and target systems that sense and can provide feedback of activity occurring in an engagement area as well as a need for a convenient way to present target hit location to soldiers as they are training. Improvised Explosive Device's (IED's) are the main cause of death/injury to our soldiers.

### SUMMARY OF THE INVENTION

The present invention provides a Non-contact ballistic tracking system using 3D Light Detection and Ranging “(LIDAR”) technology to track projectile trajectories for projectile origin location and target impact detection in shoot houses, shooting ranges, aerial targets, seaborne targets, target simulators, munitions fragmentation pattern analysis and portable shooting ranges/targets. 3D LIDAR technology may be utilized for situation awareness such as location of shooter(s) in a room/building, and controlling the response of an interactive target system based on what the approaching subject is doing.

In one aspect of the invention, the invention includes a system for detecting the trajectory of a projectile in three dimensional space. The system includes at least one pulsed laser transmitter configured to transmit pulsed laser light beams over a three dimensional area. At least one sensor is configured to sense the pulsed laser light beam reflected off of the projectile. A microprocessor is coupled to the laser transmitter and laser sensor to calculate a first position of the projectile at a first time based upon the first pulsed laser light beam reflected off the projectile and sensed by the laser sensor. A microprocessor also calculates a second position of the projectile at a second time based upon the second pulsed laser light beam reflected off the projectile and sensed by a laser sensor. A microprocessor calculates the trajectory of the projectile in three dimensional space based upon the first projectile position and the second projectile position and the time differences between these positions.

The pulsed laser sensor and pulsed laser transmitter may include a first integrated pulsed laser sensor and transmitter, and a second integrated pulsed laser transmitter and sensor. Each integrated pulsed laser sensor and transmitter includes a laser transmitter and a laser sensor which detects the position of the projectile based upon the reflected laser pulsed light off of the projectile. Each integrated laser and transmitter may also include a microprocessor within the same housing. The microprocessor calculates the position of the projectile when the pulsed laser light is reflected off the projectile and sensed by the sensor within the integrated housing. Or, each integrated laser and sensor may be coupled to an external microprocessor to perform location, distance and trajectory calculations. A microprocessor may be used to calculate the trajectory of the projectile based upon the first calculated position of the projectile and the second calculated position of the projectile and the time differences between such positions. The system may utilize one or more microprocessors for processing the pulsed light sensed signals into positional and trajectory information. The microprocessors may also calculate the location of impact of the projectile relative to a target. Also, the microprocessors may calculate the location of discharge of a projectile from a source.

The system may be utilized to calculate the trajectory and impact locations of a second projectile using the pulsed laser sensors and transmitters. The system may further include an additional pulsed laser transmitter and sensor to determine a third position of the projectile. A microprocessor may calculate the trajectory based upon the first, second and/or third positions of the projectile. The system may also be configured to communicate the location of impact of the projectile to a shooter using a visual image representation of the target and impact location via a communication network. The visual image may be projected onto a display screen proximate the scope of a weapon. The target may be displayed on the screen as an image. The first and second laser transmitters and/or sensor may be located behind the screen.

A reactive target may be used within the system which reacts based upon the location of the impact calculated by the microprocessor based upon a command received from a microprocessor. The laser transmitters and sensors may be oriented to calculate the location of a projectile discharged from 360° surrounding said target. At least three laser transmitters may be used to calculate the projectile location. The projectiles may comprise one or more fragments from an object impacted by a projectile from a weapon.

In another aspect, the invention comprises a method for detecting the trajectory of a projectile in three dimensional space. The method includes transmitting pulsed laser light beams over a three dimensional area using a first pulsed laser transmitter. At least one pulsed laser light beam reflected off the projectile is sensed using a laser sensor. A first position of the projectile is calculated at a first time based upon the reflected light beam using a microprocessor. A second pulsed laser light beam is reflected off the projectile and sensed using a laser sensor. The second position of the projectile is calculated at a second time based upon the second reflected pulsed laser light beam using a microprocessor. The trajectory of the projectile in three dimensions is calculated based upon the first calculated position and the second calculated position using a microprocessor.

The location of impact of the projectile may be calculated relative to a target. Also, the location of discharge of the projectile from a source, such as a shooter may be calculated. The trajectory and impact location of a second projectile may be calculated using the pulsed laser light beams, laser sensor, and at least one microprocessor. A third position of the projectile may be determined using an additional pulsed laser transmitter and sensor and the trajectory of the projectile may be calculated based upon or using this third position. Additional pulsed laser transmitters may emit laser pulses at times in between laser pulses from other laser transmitters to improve accuracy of the system in calculating projectile location and/or trajectory.

The location of impact of the projectile may be communicated to a shooter using a visual representation of the target and impact location. The visual image may be projected onto a display screen which may be located proximate to a scope of a weapon. The target may be displayed on a screen as an image and first and/or second laser transmitters may be located behind the screen. The target may be an actual physical reactive target which reacts based upon a command from a microprocessor and the calculated location of impact of the projectile. The location of projectiles may be calculated from anywhere within 360° surrounding the targets by using multiple laser transmitters and sensors surrounding the target. The system and method may be used to calculate the trajectory of fragments from an object impacted by a projectile from a weapon.

### BRIEF DESCRIPTION OF THE DRAWINGS

FIG. 1 is a perspective view of a shoot house having a 3D laser sensing system in accordance with the present invention;

FIG. 2 is a perspective view of an indoor shooting range utilizing 3D LIDAR tracking system in accordance with the present invention;

FIG. 3 is a perspective view of an outdoor shooting range utilizing a 3D LIDAR system in accordance with the present invention;

FIG. 3A is a perspective view of a moving infantry target utilizing 3D LIDAR technology in accordance with the present invention;

FIG. 4 depicts a bore sight zeroing target that may be used with 3D LIDAR tracking systems in accordance with the present invention;

FIG. 5 is a perspective view of an indoor simulator having 3D LIDAR systems in accordance with the present invention;

FIG. 6 is a schematic view of a 3D LIDAR system in a room of a shoot house for training exercises in accordance with the present invention;

FIG. 7 is a perspective view of a reactive target utilizing a plurality of 3D LIDAR systems in accordance with the present invention;

FIG. 8 is a perspective view of a portable reactive target utilizing a plurality of 3D LIDAR systems in accordance with the present invention;

FIG. 9 is a perspective view of an aerial gunner training exercise utilizing LIDAR technology in accordance with the present invention;

FIG. 10 is a perspective view of a visual enhancement device utilizing 3D LIDAR technology in accordance with the present invention;

FIG. 11 is a plan view of a target impact indicating scope utilizing a 3D LIDAR system in accordance with the present invention;

FIG. 12 is a depth map rendered from a LIDAR camera in accordance with the present invention;

FIG. 13 depicts a second depth map rendered from a LIDAR camera in accordance with the present invention;

FIG. 14 is a perspective view of a LIDAR camera mounted on a helicopter in accordance with the present invention;

FIG. 15 is a diagram of a ground disturbance recognition system in accordance with the present invention;

FIG. 16 is a perspective view of a LIDAR system for tracking a bullet in accordance with the present invention; and

FIG. 17 is a perspective view of a LIDAR camera utilized in accordance with the present invention.

### DETAILED DESCRIPTION

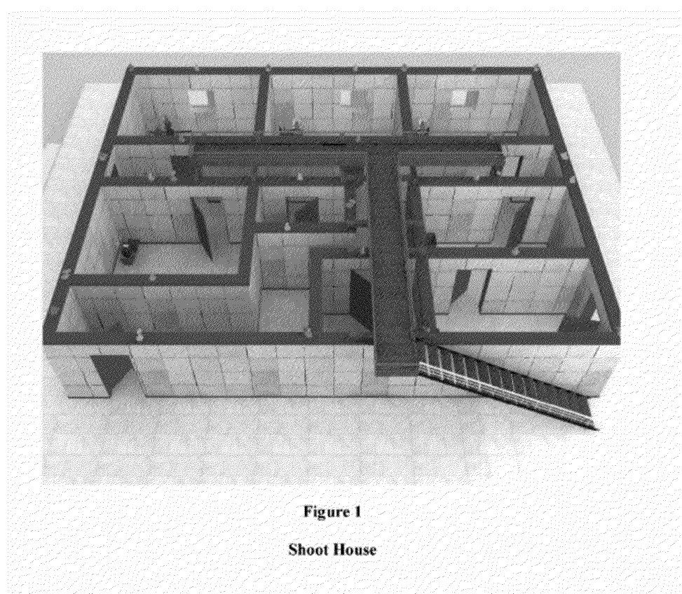

FIG. 1 shows a typical shoot house where a 3D laser sensing system (LIDAR) is used in both the rooms and hallways to detect the presence of shoots and tract projectile trajectories relevant to targets to determine the lethality of target impact. Both live fire and non-live fire projectiles, such as paintball, simunition, etc may be detected and tracked using such a LIDAR system. 3D LIDAR technology may also be used to locate the shooter positional information, control a response of interactive targets, determine an origin (i.e., original location) of a shooter (in multi-shooter scenario) and where to orientate a rotating pop-up mannequin target and/or point shoot back devices in order to engage an active threat. The LIDAR system described above, and those described below, may be one according to U.S. Pat. Nos. 6,133,989 & 6,414,746 describe which can detect objects using a diffused pulsed laser beam and an optic sensor.

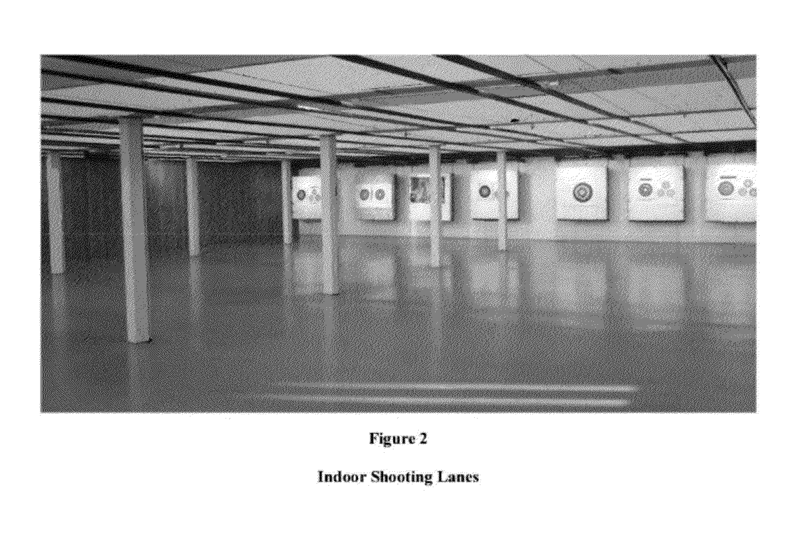

FIG. 2 shows an indoor shooting range where one or more 3D LIDAR tracking systems in the corner of the range looking across all lanes to tract projectile trajectory and determine target impact location for each lane simultaneously. Multiple tracking systems can be synchronized to fire at different times thereby increasing the sample rate of the target acquisition system.

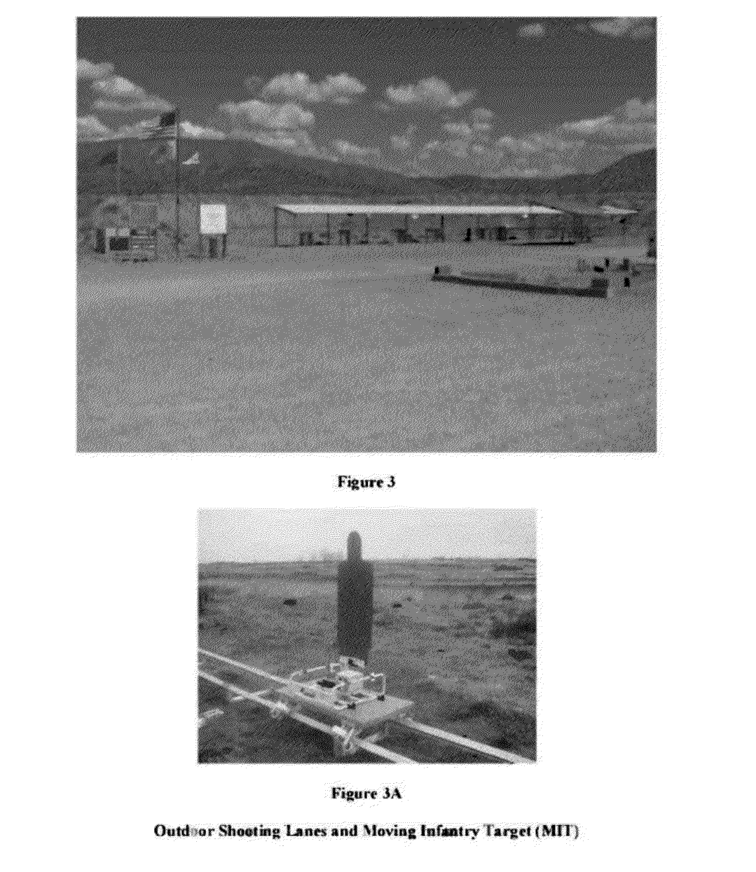

FIG. 3 shows an outdoor shooting range where 3D LIDAR systems may be synchronized with a control system (e.g., a computing unit such as a personal computer running a WINDOWS operating system) to create a projectile tracking system that determines a target impact location for all lanes simultaneously. FIG. 3A also shows a moving infantry target (MIT) that may use 3D LIDAR technology either mounted on the moving target or in a stationary position to sweep in front of a moving target for leading/lagging impact detection.

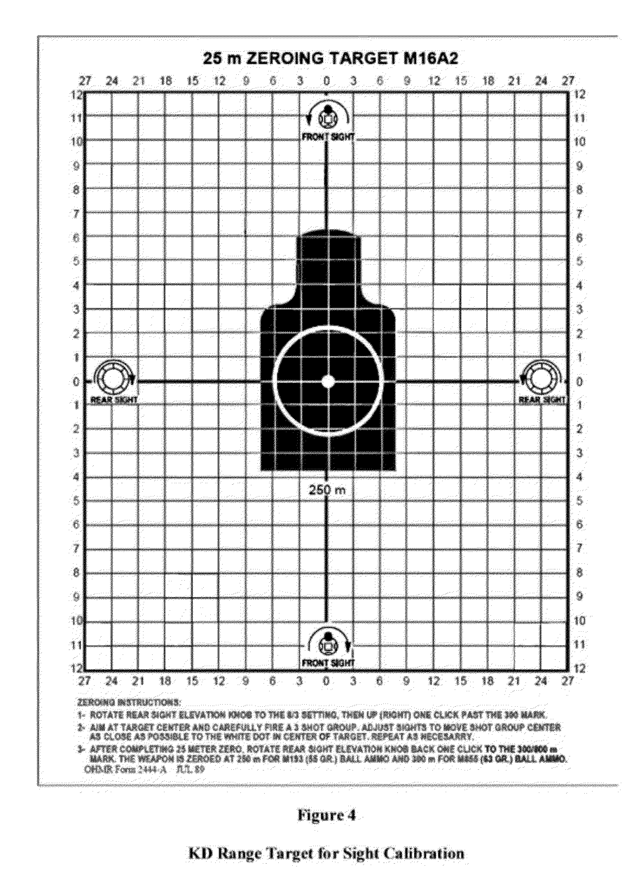

FIG. 4 shows a typical bore sight zeroing target that are used on military Known Distance (KD) ranges. The targets are used to calibrate sights of a weapon. In a typical prior art training exercise, a shooter shoots 3 rounds through his scope and waits for all other shooters to shoot their 3 rounds. The shooters they all place their weapons down and walk down range and analyze the grouping pattern on the targets to determine the centroid of the grouping. The shooters then count the lines over and down/up to the center of the target and use their measurement of the number of lines to determine how many clicks on their scope sight that they should adjust to correct the bore sight. In an embodiment according to the present invention, one or more 3D LIDAR tracking system(s) may be utilized such that a group of shooters could simply shoot at a set of targets and the 3D LIDAR system could track and locate all impacts on multiple targets simultaneously.

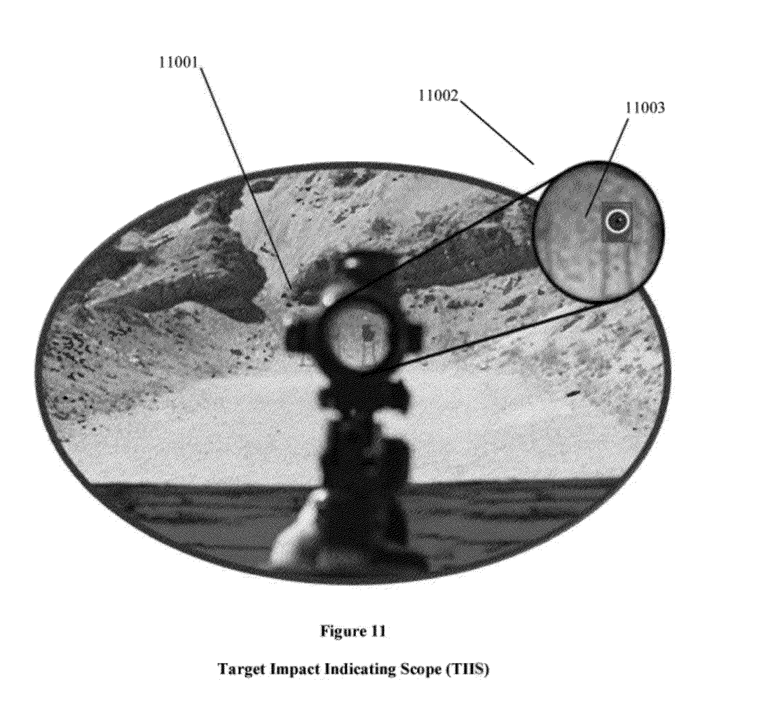

A “snap on” (or otherwise easily attachable) Target Impact Indicating Scope (TIIS) Heads Up Display (HUD) lens system may be attached to existing scopes of the shooters described and a range control system coupled to or part of the 3D LIDAR tracking system(s) could automatically communicate to each individual shooter's TIIS HUD and calculate the correction information along with a visual representation of where the centroid of their last shot pattern was in reference to the bull's eye or center of the target. The “Snap On” HUD lens can be produced using LCD, projection, or similar known LCD technologies. By making a snap on lens cover HUD version of a scope as depicted in FIG. 11, a shooter may use his own scope and therefore not to disturb the calibration set at the KD range. The communication system that links the range tracking system to TIIS HUD system could be a wireless protocol such as Bluetooth or 802.11 or a wired protocol such as USB or Ethernet. This system would save time and money on bore sight calibration for both KD ranges as well as on tank ranges bore sight calibration ranges. This same system could be used for targetry impact detection on standard and moving ranges as well.

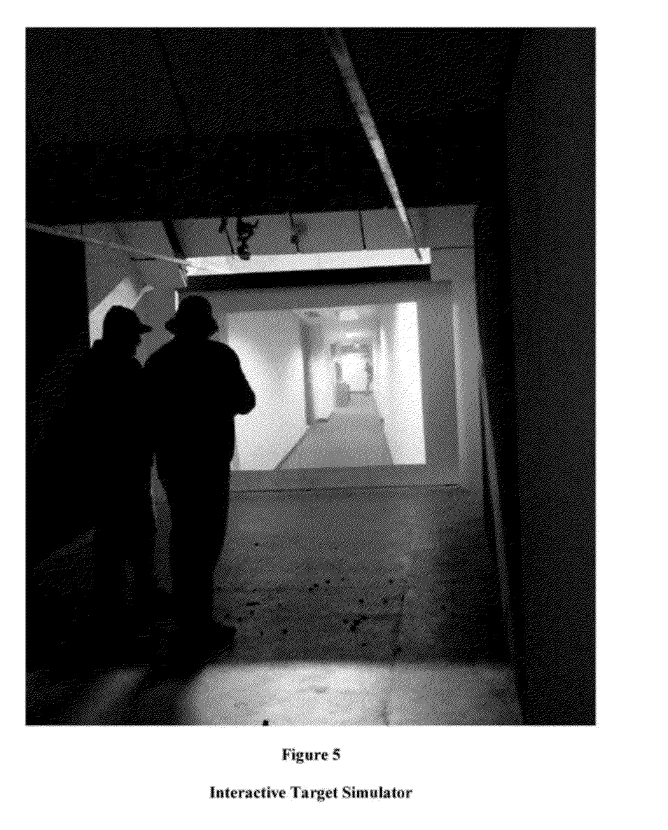

FIG. 5 shows an indoor simulator where one or more 3D LIDAR systems are located either behind a screen to detect live fire projectile trajectories or in a corner(s) of the room to detect projectile and/or laser impact locations and synchronize a response with an interactive video playback as well as point shoot back devices.

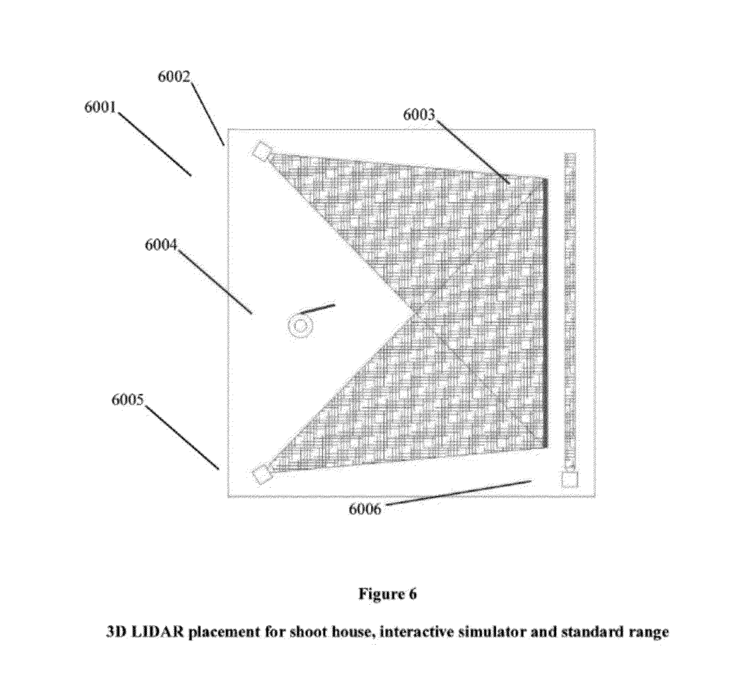

In one example, FIG. 6 shows possible configurations of a 3D LIDAR system in a shoot house room 6001, virtual interactive screen target system 6003, or on a standard indoor/outdoor shooting range as shown in FIG. 5 and FIG. 3 respectively. In a shoot house one or more 3D LIDAR system(s) 6002 and 6005 can be place above the no-shoot line in the corner near the entry point of the room sweeping past a shooter 6004 across an interactive screen. Each LIDAR system may include an integrated unit having a pulsed laser transmitter, laser sensor, and microprocessor therein, such as those available from Advanced Scientific Concepts, Inc. of Santa Barbara, Calif., U.S.A. Such systems are capable of determining and calculating the position of an object in three dimensional space by detecting pulsed laser beams emitted from the transmitter reflected off the object and sensed by the sensor. Such systems are described in U.S. Pat. Nos. 6,414,746 and 6,133,989, each of which are incorporated herein by reference in their entireties. One or more 3D LIDAR system(s) could be placed behind an interactive screen 6006 and capture a trajectory of a bullet as it passes through a narrow plane type of beam. Such a beam would have a laser on all of the time and would be behind the screen and not pointed outward toward the shooter to prevent potential eye damage. In another embodiment two overlapping 3D LIDAR cameras could be placed on upper corners of a target facing a doorway to allow the cameras to digitally track activity of the shooters as well as track bullets shot at a target. The tracking of the bullets would also allow the acquisition system (e.g., the microprocessor) to determine which shooter shot which bullet by creating a vector from subtracting 2 depth mapped frames bullet locations X/Y/Z information and comparing that with shooter's weapon orientation at the time the corresponding image was captured by the camera.

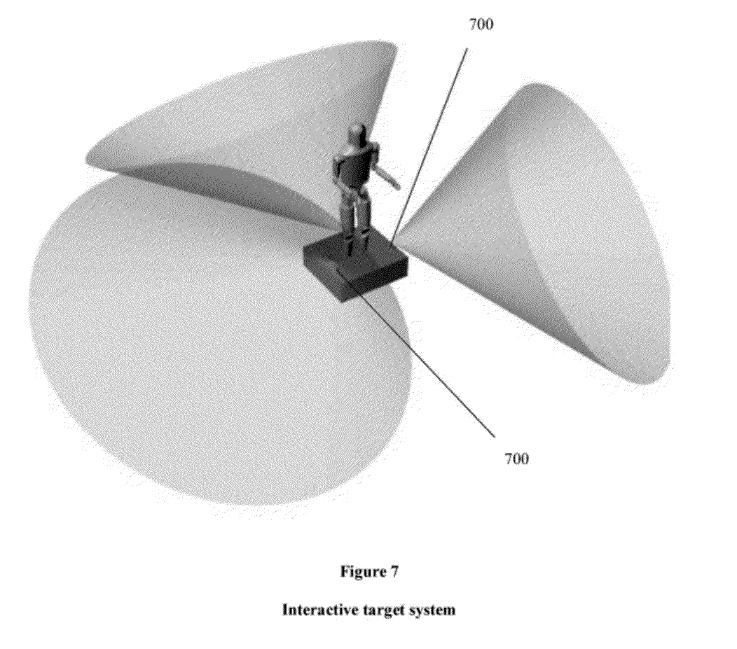

FIG. 7 shows a reactive target where one or more 3D LIDAR systems 700 may be used to detect both projectile impact location(s) on an interactive target and to allow situational awareness to correctly control a reactive target response. For example, the one or more 3D LIDAR systems could sense a shooter aiming at, or shooting toward, a target and the system, or a computing unit coupled to the system(s), could control a motor to rotate the target toward the shooter. One or more 3D LIDAR system(s) could also be placed in the corner of a room as shown in FIG. 6 and track both situational awareness, e.g., track the location and actions of a shooter or other actor in a room, track the trajectory of one or more projectiles and send the data collected to a reactive target controller coupled to a motor connected to a target to command the target to respond accordingly. For example, a target may be controlled to fall down if lethally shot or rotate toward or move toward a shooter(s), and/or raise a weapon and fire at the shooter.

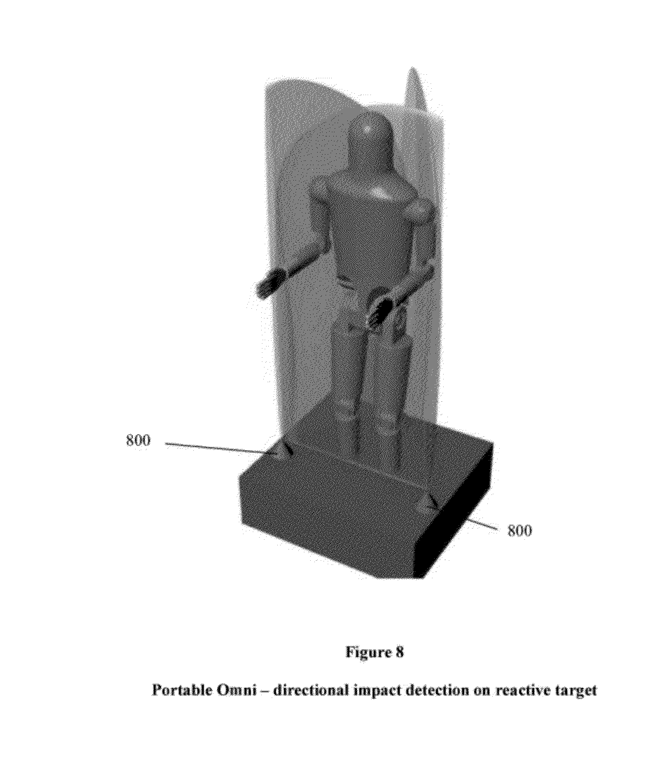

FIG. 8 show portable reactive target where one or multiple 3D LIDAR systems 800 may be used to create a portable non-contact based Omni-directional impact detection system. This system would be able to detect impacts coming from 360 degrees, determine the lethality of impact of any projectiles and respond accordingly. The system may be configured with a single laser and multiple detectors or could be configured with one laser/detector on a servo that sweeps around and acquires bullet trajectory as a standard radar sweeps an area. In another example, 4 laser/planar focal point arrays could be used to track each quadrant.

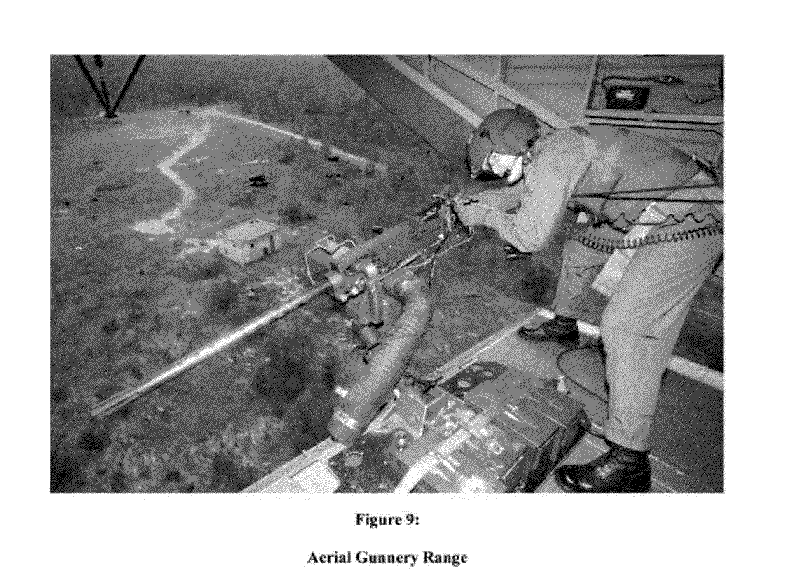

FIG. 9 shows an aerial gunner engaged in a training exercise in an aerial gunnery range. 3D LIDAR technology may be utilized in aerial gunnery ranges to determine target impact accuracy and lethality of weapons such as mini gun and aerial bomb placement. One or more 3D LIDAR systems may be strategically located such that the one or more systems are all aimed toward an impact area of a bombing range and thus accurate bomb placement can be determined using such systems. Multiple laser/focal point arrays may be used to detect the impact location and fragmentation pattern of detonated war head. Each laser/focal point array system could operate on a different wavelength and each focal point array could be tuned to only see that spectrum of light thereby inhibiting or preventing cross talk across systems. Further, each laser/focal point array could be timed to fire and sense at different times from each other. Also, an entire acquisition system data coupled to the one or more 3D LIDAR systems could be aggregated into one virtual multigrid array such that the entire bomb placement/fragmentation pattern could be reconstructed using vector analysis and fragment tagging algorithms.

In another example, 3D LIDAR technology can be used at military operations in urban terrain (MOUT) and/or combined arms training center (CATC) where the impact location on targets can be used to determine the lethality/effectiveness force on target engagements. This is easily accomplished by strategically placing one or more 3D LIDAR systems throughout the campus so that a maximum coverage in front of any given target may be accomplished.

In a further example, 3D LIDAR technology may be used to determine the effectiveness of suppressive fire which is hard to quantify. By looking at a dispersion rate, area of coverage and total suppression time an accurate assessment can be performed. The 3D LIDAR technology can calculate the round density/sq foot and give a quantitative analysis.

In another example, 3D LIDAR technology (e.g., one or more 3D LIDAR systems coupled to one or more computing units to process data collected and/or control movement of targets) could be placed in a shoot house or CATC center to detect and determine the placement/effectiveness or lethality of new technologies such as the Counter Defilade Target Engagement (CDTE), XM-25 with smart munition airburst rounds. One or more 3D LIDAR systems coupled to one or more computing units may be used to calculate a dummy round entry point through a window and, if synchronized with a fused time delay programmed by the weapon, determine detonation location and determine the lethality of an engagement. 3D LIDAR technology (e.g., one or more 3D LIDAR systems coupled to one or more computing units to process data collected and/or control movement of targets) may be utilized in tow missile simulator lasering/aiming such that a location can accurately be determined by calculating an exact impact location of target lasering system.

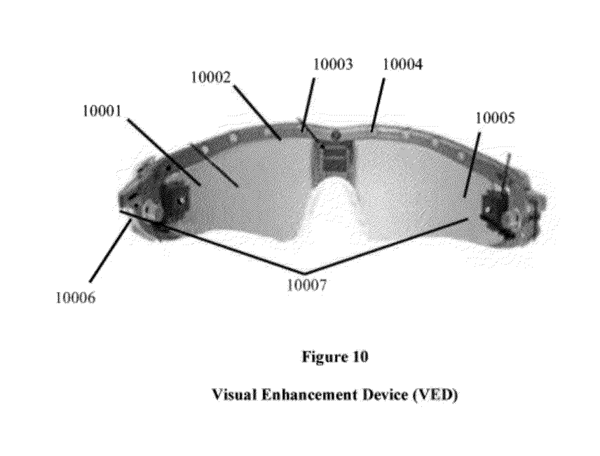

FIG. 10 shows a visual enhancement device (VED) 10001 where 3D LIDAR technology can be combined with thermal, night vision and visual cameras to create a system that will help fire fighters find their way into and out of burning buildings or give soldiers a tactical advantage. The VED can also be integrated right into a user's (e.g., fire fighter's or soldier's) suit. In one example, VED 1001 includes a glasses Heads Up Display (HUD) and audio interface communicating with a PDA (personal digital assistant) or other small computing device located in the user's jacket via wireless protocols, such as Bluetooth or 802.11 or wired protocols such as USB, Ethernet, etc. An onboard computer 10002 acquires data from a MEMS Gyro & compass 10006 and a thermal/night vision/visual camera 10005 along with optic sensors 10004 which may detect in which direction a user's eyes are focused. The onboard computer may control audio speakers/bone speakers built into the PDA as well as a 3D LIDAR laser 10003 and a plurality (e.g., two) of stereo optical focal point array detectors 10007. The PDA may have onboard memory as well as a GPS tracking system and enough processing power to dynamically map data in real-time. As the user moves around in a building the PDA may store all 3D data in a database and may dynamically reconstruct the rooms as the user moves through the building. If multiple users are traveling together a mesh network may be used to synchronizing data from each user with each other user such that the floor plan may be dynamically mapped on the fly using the real time data gathered by the system(s) carried by each user. As they traverse through the building the system integrates all this data and may plan (e.g., map out) an optimal exit route. For example, if a more direct exit is available the user can tap the glasses and say “Exit Here” while looking at exit point. Or in a tactical mode the user may simply blink repeatedly while looking toward the exit point and record/mark exit location. Also points of interest may be tagged and recorded while in route to final objective either with voice tags or simple head/eye gestures. When returning back through the building, via an optimized route predetermined from 3D LIDAR data, visual cues may show up on each user's HUD such as displaying an arrow indicating a direction to travel. Audio between users (e.g., firefighters) as well as real-time biometric data may be displayed on HUD to indicate a status of other users. If a particular user gets hurt or is getting too hot a nearby user (e.g., fireman) may respond quickly. In a tactical situation, when traversing back through a building, if something is out of place, (e.g., a chair, door position, window opened, etc.) since the room was mapped previously using a LIDAR system as described above, the HUD may immediately highlight the difference (e.g., disturbance) to alert the soldier of possible danger in the immediate vicinity due to such change(s) in the mapped area.

FIG. 11 shows a Target Impact Indicating Scope (TIIS) 11001 where 3D LIDAR technology is used to detect and display a shot trajectory and a shot impact location on a target using a Heads Up Display (HUD) system. Such a 3D LIDAR system may be connected to, or coupled to, such a scope, for example. The scope may use such a 3D LIDAR system to track the trajectory of a bullet as it goes down range. The LIDAR system, including any computing unit which may be coupled to such a system, also may track a position of a target with respect to the bullet, and in 2 or more frame captures, may determine a final impact location of the bullet. HUD 11002 may then display this information to the shooter in real-time by using the 3D LIDAR system to determine the position/outline of the target where the system may display the target outline and bullet impact location 11003 by highlighting an area on the visual target.

3D LIDAR technology may also be used to create a Real-Time Sniper Locator (RTSL) Scope by tracking incoming rounds while engaging a sniper. The scope would have all the sensors described above relative to the VED in FIG. 10 and would communicate with other soldiers RTSL scopes to aggregate trajectory information and triangulate the exact position of the sniper. This GPS & elevation information could then be shared wirelessly to facilitate further action. For example, such information could be wirelessly uploaded into a TOW missile and fired at the sniper. In another example, scope crosshairs on each of the engaging friendly shooters RTSL scope could be positioned on the HUD to the exact sniper location. 3D LIDAR technology may be used to detect movement of objects along desired shot path and calculate cross wind information from analyzing the movement at different distances out of each object. The RTSL scope could use that data to offset the crosshairs in the RTSL scope to compensate for any such additional information determined by a 3D LIDAR system.

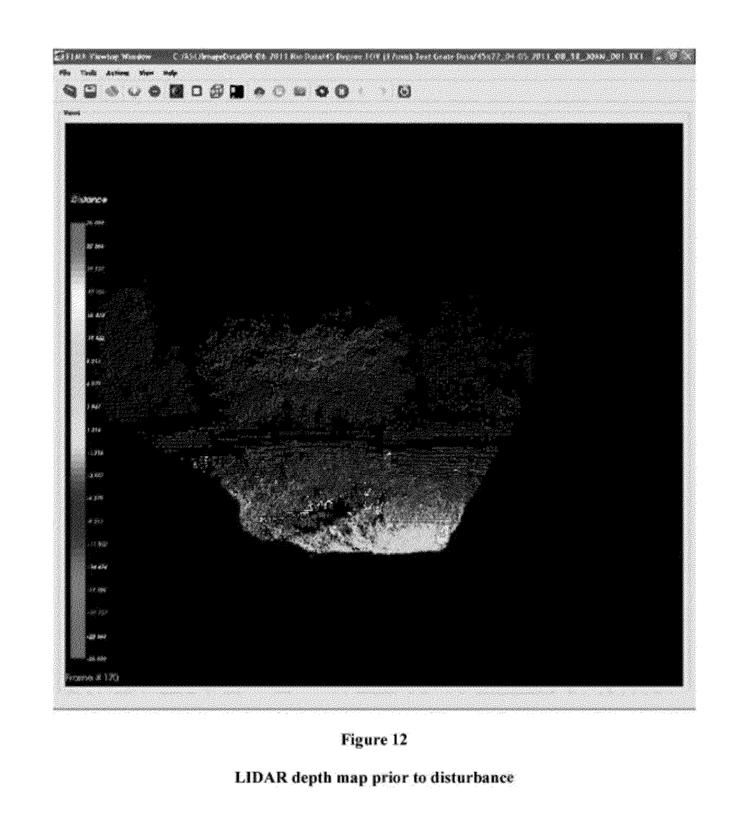

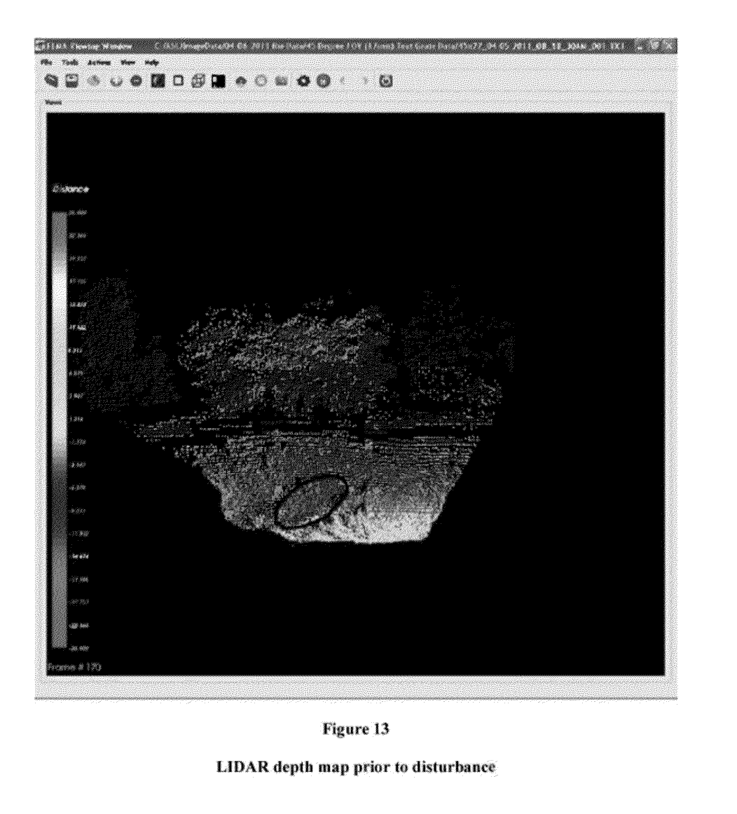

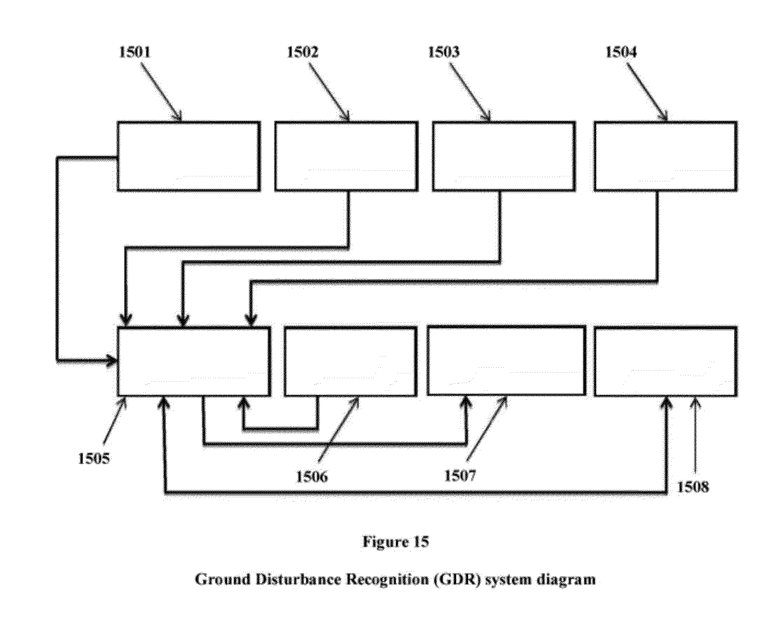

FIG. 12 shows a depth map rendered from a LIDAR camera. FIG. 13 depicts a map imaged after the image in FIG. 12 was captured, for example. FIG. 13 shows a depth map captured via the LIDAR camera and compared to the previously stored data (e.g., that data represented by FIG. 12). By Geo tagging the ground data and comparing it with newly acquired depth map a disturbance recognition (DR) system may recognize the area circled in FIG. 13 had changed from previously mapped data. Such a change in this mapped area could alert a soldier that there could be an anomaly, such as a buried IED or booby trap in that area. In another example, if trip lines were laid down on the ground, a LIDAR system coupled to a display or other means for providing an indication of the data collected could automatically detect and alert soldiers of potential harm. In this embodiment the data may be stored as raw XYZ data points (e.g., a Depth Map) along with camera orientation information generated by a system shown in FIG. 15. By utilizing information recorded relative to camera orientation(s) to the ground, each data pixel may be translated to a common point in space, e.g., centered in the depth map view 100 feet vertically.

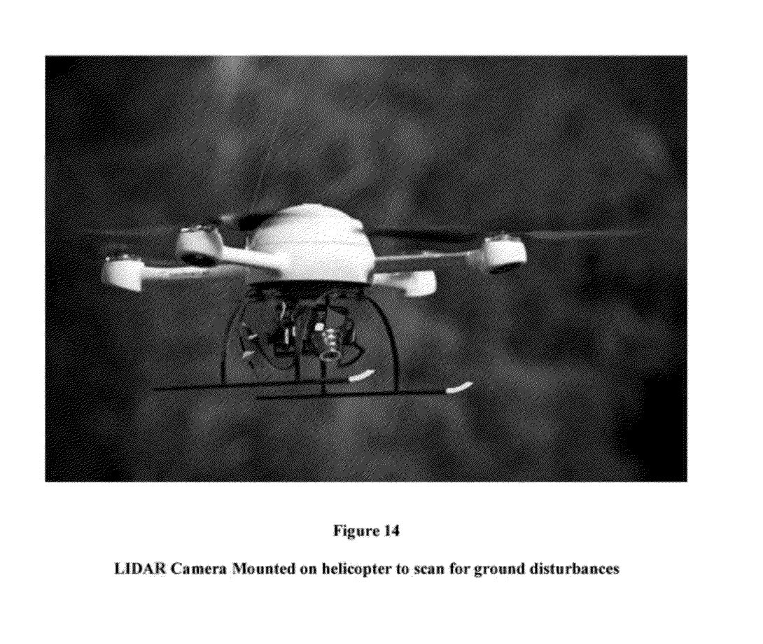

FIG. 14 shows a LIDAR camera mounted on a helicopter scanning an area. Such a helicopter and a LIDAR camera mounted in this way could provide mapping of an area as described above which may provide information relative to disturbances occurring between successive mappings of the area. Such a system used to determine disturbance recognition could also be mounted on jeeps, trucks, planes, bomb robot, or attached to a gimbal on a UAV, for example.

FIG. 15 Shows a system diagram embodiment of a Ground Disturbance Recognition system, which may be utilized to detect disturbances (e.g., changes) in a three dimensional space as described above, and which includes a 3D camera 1501 coupled to a central processor or system controller/operating system 1505. 3D camera 1501 may provide LIDAR images (e.g., depth maps of area detected within a camera's field of view) to the processor. A gyroscope 1502 may supply pitch, roll, and yaw information of the camera's orientation to a system controller coupled (e.g., wirelessly) to the gyroscope and/or camera. A GPS receiver 1503 may supply GPS coordinates to the system controller. A compass may send the camera's global orientation/rotation information to the system controller. Also, an Altimeter 1506 sends the camera's altitude information to the system controller/operating system.

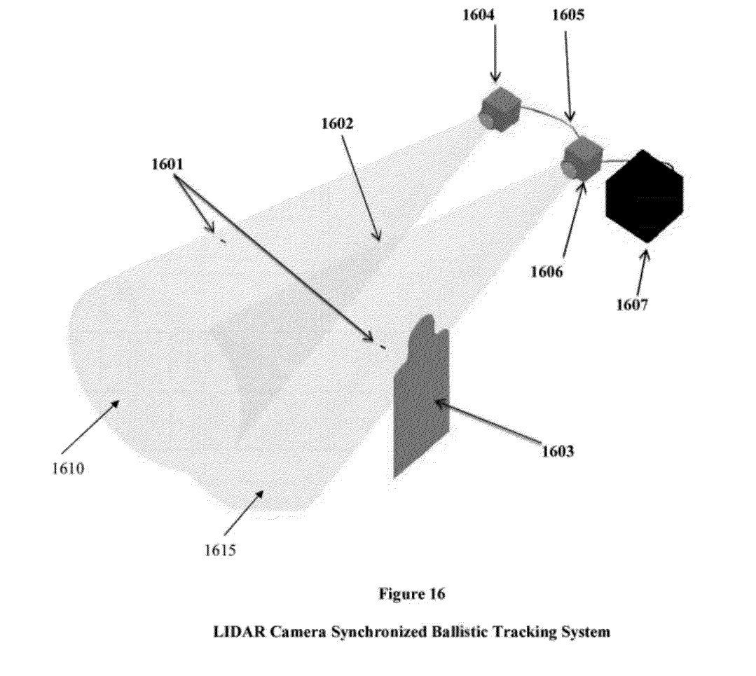

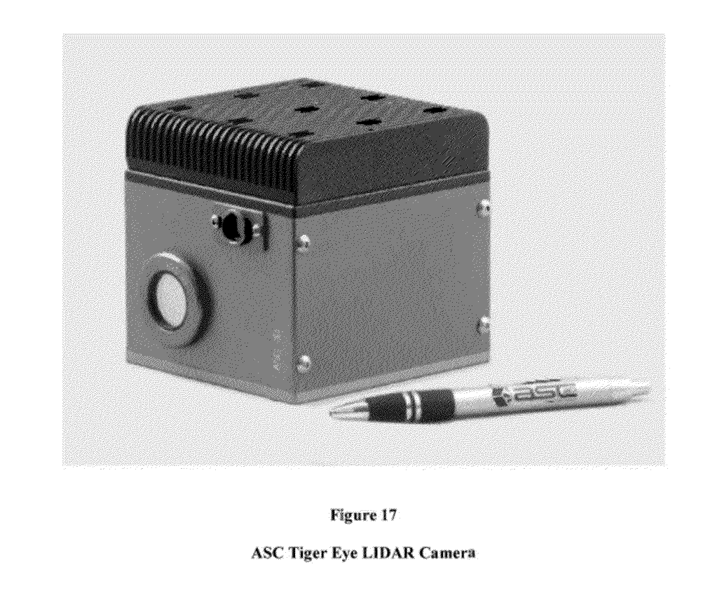

FIG. 16 Shows a bullet 1601 at two locations as bullet 1601 travels through two LIDAR laser fields 1602 that are synchronized to fire alternately as the bullet moves to impact a target 1603. Two LIDAR cameras 1604 and 1606 in this embodiment may be ASC's Tiger Eye camera shown in FIG. 17, for example. Each LIDAR camera would the data captured thereby through a high speed data cable 1605 to an acquisition system 1607 where two depth maps (i.e., from cameras 1604 & 1606) get correctly aligned and compared to previously stored depth maps. When the bullet enters a first laser field 1610 of fields 1602 its pixel location is translated to an absolute X-Y-Z point and when the same bullet hits s second laser field 1615 of fields 1602 its pixel location is translated to a second absolute X-Y-Z point. This can be done by memory mapping both focal point array depth maps so that they directly correlate to the laser field view of each camera. Vector math may be used to calculate the direction vector and the velocity vector (when combined with time). The velocity vector combined with the pixel count may be used to determine the size of the bullet or other projectile impacting the target. For example, the X coordinate, representing the horizontal projectile location, is determined by a processor recording the specific pixel within the laser sensor which senses the pulsed laser reflected off the projectile. Similarly, the Y coordinate, representing the vertical position of the projectile location, is also determined by the specific pixel within the laser sensor which senses the reflected laser pulse. Accordingly, the specific pixel within the laser sensor which senses the reflected pulsed laser represents the X Y coordinate of the projectile at a first time. The Z coordinate, representing the distance of the projectile from the laser sensor is determined using time of flight of the pulse reflected off the projectile from the time the laser pulse is initiated from the time the reflected laser pulse is sensed by the pixel within the sensor. Each LIDAR camera 1604, 1606 is used to determine the X, Y and Z position of the projectile at different times. The specific techniques to calculate the location of an object at a particular time is described in detail in U.S. Pat. Nos. 6,133,989 and 6,414,746, the specifications of each of which are incorporated herein by reference. By calculating the projectile position at a first time using the data from the first LIDAR camera 1604 and calculating the position of the projectile at a second time using the data from the second LIDAR camera 1606, the velocity, i.e., speed and direction of travel of the projectile may be calculated using three dimensional vector mathematics and time differences. Each LIDAR camera 1604 and 1606 includes an integrated pulsed laser transmitter and pulsed laser sensor, each sensor comprised of an array of individual pixels which are capable of sensing the reflected pulsed laser light. Such LIDAR cameras are available from advanced Scientific Concepts, Inc., of Santa Barbara, Calif. under the trademark TIGEREYE® and are described in U.S. Pat. Nos. 6,414,746 and 6,113,989.

Further to the examples described above, 3D LIDAR systems could be used with thermal, night vision, and visual data to produce a visual enhancement system for soldiers and/or firemen to give them a significant tactical advantage in situational awareness. As described, LIDAR systems may also be used to identify disturbed areas by comparing multiple depth map images taken at different times and determining the changes that have occurred between them. Using 3D laser/IR technology round impact from land, air or sea may be determined as well as analysis of warhead fragmentation patterns. Using 3D laser/IR technology ground disturbance from land and air can be determined. A soldier may utilize this technology to not only detect possible IED locations but also to detect IED detonation wires, trip wires as well as gaining enhanced situational awareness in poor visibility conditions.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

1. A method for detecting the trajectory of a projectile in three dimensional space comprising:
transmitting pulsed laser light beams over a three dimensional area using a first pulsed laser transmitter;
sensing at least one pulsed laser light beam reflected off said projectile using a laser sensor and calculating a first position of said projectile at a first time based upon said reflected at least one laser light beam using a microprocessor;
sensing at least one pulsed second laser light beam reflected off said projectile using a laser sensor and calculating the second position of said projectile at a second time based upon said at least one second reflected laser light beams using a microprocessor; and
calculating the trajectory of said projectile in three dimensions based upon said first calculated position and said second calculated position, using a microprocessor.

2. The method of claim 1 further comprising calculating the location of impact of the projectile relative to a target.

3. The method of claim 1 further comprising calculating the locating of discharge of the projectile from a source.

4. The method of claim 2 further comprising calculating the trajectory and impact location of a second projectile using pulsed laser light beams and a laser sensor.

5. The method of claim 1 further comprising using a second pulsed laser transmitter and a second laser sensor to determine a second position of said projectile and calculating said trajectory based upon said second position.

6. The method of claim 5 wherein said second pulsed laser transmitter emits laser pulses at times in between laser pulses from said first laser transmitter.

7. The method of claim 2 further comprising communicating the location of impact of said projectile to a shooter using a visual image representation of said target and impact location, using a communication network.

8. The method of claim 7 wherein said visual image is projected onto a display screen proximate a scope of a weapon.

9. The method of claim 2 wherein said target is displayed on a screen as an image.

10. The method of claim 2 wherein one of said first and second laser transmitters are located behind said screen.

11. The method of claim 2 wherein said target comprises a reactive target and said reactive target reacts based upon the location of said impact and a compound from a microprocessor.

12. The method of claim 5 wherein said laser transmitters are oriented to calculate the location of projectiles discharged from 360 degrees of said target.

13. The method of claim 12 wherein at least three laser transmitters are used to calculate said projectile location.

14. The method of claim 1 wherein said projectile comprises one or more fragments from an object impacted by a projectile from a weapon.

15. A system for detecting the trajectory of a projectile in three dimensional space comprising:
at least one pulsed laser transmitter configured to transmit pulsed laser light beams over a three dimensional area;
at least one laser sensor configured to sense at least one pulsed laser light beam reflected off of said projectile;
at least one microprocessor coupled to said at least one laser transmitted and said laser sensor to calculate a first position of said projectile at a first time based upon a first pulse laser light beam reflected off of said projectile and sensed by said at least one laser sensor, and calculate a second position of said projectile at a second time based upon a second pulsed laser light beam reflected off of said projectile and sensed by said at least one laser sensor;
wherein said at least one microprocessor calculates the trajectory of said projectile in three dimensional space based upon said first projectile position and said second projectile position.

16. The system of claim 15 wherein said at least one pulsed laser sensor and said at least one pulsed laser transmitter comprise a first integrated pulsed laser sensor and transmitter, and a second integrated pulsed laser transmitter and sensor.

17. The system of claim 16 wherein said first integrated pulsed laser sensor and transmitter includes a microprocessor therein for calculating the first position of said projectile, and said second integrated pulse laser transmitter and sensor includes a microprocessor for calculating the second position of said projectile.

18. The system of claim 16 wherein the microprocessor calculates the location of impact of a projectile relative to a target.

19. The system of claim 18 wherein the microprocessor calculates the location of discharge of the projectile from a source.

20. The system of claim 19 wherein a microprocessor calculates the trajectory and impact location of a second projectile using pulsed laser light beams and a laser sensor.

21. The system of claim 20 further comprising a third integrated pulsed laser and sensor to determine a third position of the projectile in a microprocessor for calculating the trajectory of the projectile based upon the third position.

22. The system of claim 21 wherein the third pulsed laser transmitter emits laser pulses at times in between laser pulses from the first laser transmitter.

23. The system of claim 22 further comprising a communication network for communicating the location of impact of the projectile to a shooter using a visual image representation of the target and impact location.

24. The system of claim 23 wherein the visual image is projected onto a display screen proximate a scope of a weapon.

25. The system of claim 24 wherein the target is displayed on a screen as an image.

26. The system of claim 25 wherein a pulsed laser transmitter and sensor are located behind the screen.

27. The system of claim 17 further comprising a reactive target configured to physically react based upon a command from a microprocessor and the calculated location of impact of the projectile.

28. The system of claim 17 wherein the pulsed laser transmitters and sensors are oriented to calculate the location of projectiles discharged from 360° surrounding the target.

29. The system of claim 28 wherein at least three pulsed laser transmitters are used to calculate the projectile location.

30. The system of claim 17 wherein the projectile comprises one or more fragments from an object impacted by a projectile from a weapon.

31. A method for detecting a disturbance in three dimensional space, the method comprising:
transmitting a first plurality of pulsed laser light beams over a three dimensional area using a pulsed laser transmitter;
sensing a first pulsed laser light beam reflected off at least one portion of the three dimensional area using a laser sensor and electronically storing a first unit of information relative to the at least one portion of the three dimensional area;
transmitting a second plurality of pulsed laser light beams over the three dimensional area;
sensing a second pulsed second laser light beam reflected off the at least one portion of the three dimensional area and electronically storing a second unit of information relative to the at least one portion of the three dimensional area;
comparing the first unit of information to the second unit of information by a microprocessor to determine a disturbance or a non-disturbance to the at least one portion of the three dimensional area.

32. The method of claim 31 further providing an indication of the disturbance to a user via an electronic display.

33. The method of claim 31 further providing an indication of the non-disturbance to a user via an electronic display.

34. The method of claim 31 wherein the second plurality of pulsed laser light beams is transmitted by a second pulsed laser transmitter different from the pulsed laser transmitter.

35. The method of claim 31 wherein the sensing the second pulsed second laser light beam comprises sensing by a second laser sensor different from the laser sensor.

36. The method of claim 31 wherein the laser transmitter and the laser sensor are connected to a vehicle and the transmitting and the sensing occur while the vehicle is in motion.

37. The method of claim 31 wherein the first unit of information and the second unit of information are communicated to the microprocessor and the storing of the first unit of information comprises storing on a storage device coupled to the microprocessor and the storing of the second unit of information comprises storing on the storage device coupled to the microprocessor.

38. The method of claim 31 wherein the first unit of information comprises a first image of the at least one portion of the three dimensional area and the second unit of information comprises a second image of the at least one portion of the three dimensional area.

39. The method of claim 31 wherein the first unit of information comprises information relative to a location of the sensor.

40. The method of claim 31 wherein the first unit of information comprises information relative to a location of the transmitter.

41. The method of claim 31 wherein the first unit of information comprises a depth map of the at least one portion of the three dimensional area and the second unit of information comprises a second depth map of the at least one portion of the three dimensional area.

42. A system for detecting a disturbance in three dimensional space, the system comprising:
a pulsed laser transmitter configured to transmit a first plurality of pulsed laser light beams over a three dimensional area;
a laser sensor configured to sense a first pulsed laser light beam reflected off at least one portion of the three dimensional area at a first time and a second pulsed laser light beam reflected off the at least one portion of the three dimensional area at a second time;
at least one electronic storage means configured to electronically store a first unit of information relative to the at least one portion of the three dimensional area at the first time and a second unit of information relative to the at least one portion of the three dimensional area at the second time;
a microprocessor configured to compare the first unit of information to the second unit of information by to determine a disturbance or a non-disturbance to the at least one portion of the three dimensional area.
